(19) United States
(12) Patent Application Publication
(10) Pub. No.: US 2006/0212179 A1
(43) Pub. Date: Sep. 21, 2006

(54) Stand-alone car receiver

(75) Inventors: Lieven Philips, Langdorp (BE); Michael Dieudonne, Leuven (BE)

Correspondence Address: Paul D. Greeley;Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 11/361,719

(22) Filed: Feb. 24, 2006

(30) Foreign Application Priority Data
Mar. 9, 2005 (GB) 0504824.4

(51) Int. Cl. G06F 17/00

(52) U.S. Cl. 701/1

(57) ABSTRACT

A receiver system comprising a receiver module, a server subsystem to handle received data, a local storage device to retain said received data and a connectivity box for connecting external links.

### FIELD OF THE INVENTION

The present invention relates to a stand-alone car receiver for a car entertainment or infotainment system.

### STATE OF THE ART

Car entertainment and car infotainment systems are becoming more and more complex. Customers are interested in having increased functionality and connectivity in an integrated system. In order for these systems to become a commercial success, technical solutions enabling cost reduction for the use of these multimedia devices by the average user will be needed.

The software defined radio (SDR) concept is used to describe radios that provide software control of a variety of modulation techniques, wide-band or narrow-band operation and waveform requirements of current and evolving standards over a broad frequency range. It is applicable across a wide range of areas within the wireless industry. With SDR, one aims to implement a common hardware platform and accommodate various standards and technologies via software modules and firmware.

Multimedia systems are becoming more and more apparent in the automotive and mobile market. Currently, DAB, T-UMTS and DVB-T are formats capable of delivering multimedia information to car-mounted systems. Another technology that can serve this market is WiMAX IEEE802.16, and especially the Mobile WiMAX IEEE802.16e variant, which will provide internet access to mobile platforms using an extension of the WLAN technology. Similarly there is 802.MBWA (Mobile Broadband Wireless Access). Although not being a broadcast or multicast technology, WiMAX could develop quickly on a commercial basis and should therefore not be ignored for this type of car based services. The quantity of systems in the field is also increasing, and therefore extra broadcasting layers are proposed such as Multimedia Broadcast Multicast Service (MBMS). Car systems also need the reception of GPS or Galileo signals in order to allow location based services to become more effective in front of the growing user community.

The connectivity problem is mainly reflected in the cost of integrating multimedia systems in a car environment. Additional peripherals need to be installed such as an information bus, extra displays, . . . Today the average user is not able to spend a large amount in order to afford the system, making it suitable only for the high-end system niche.

The main disadvantages faced by the current users are the cost and the quantity of separate receiver modules needed to support the different formats. Special receivers need to be purchased in order to have the necessary functionalities requested by the end user. Current consumer products support FM and DAB reception. Except for high-end cars, GPS (or future Galileo) reception requires the user to purchase an additional receiver that is mounted in the car. The current technical solutions have already reached some inter-system interaction level such as GPS/RDS, but no solution has been found yet for future interaction between e.g. Satellite Digital Multimedia Broadcast (S-DMB) and Galileo. Most of the information received is currently audio and can be played through the car's audio system. Future systems will provide multimedia content (including images and video) and will need new user interfaces in the car, which can be expensive.

The S-DMB concept is a concept originating from the mobile market. Its purpose is to broadcast multimedia information towards mobile users on their 3G handhelds. The S-DMB concept is a satellite based overlay system of the 3G terrestrial networks. However, S-DMB suffers from a limited indoor penetration and a poor coverage in some environments (e.g. shadowing, large multipath profiles, . . . ). The S-DMB concept is currently not addressing the automotive entertainment industry. However, S-DMB service reception in the car is beneficial for the car passenger entertainment and ‘infotainment’ as push and store and streaming services are provided.

Patent document EP1152254 (also U.S. Pat. No. 6,351,236) relates to a mobile transceiver that combines GPS and CDMA. The receiver is equipped with both a CDMA Tx/Rx antenna and a GPS Rx antenna. Separate GPS and CDMA sections are used to process the respective signals. A select path selector is foreseen to select the appropriate section.

WO97/14056 discloses a combined GPS positioning system and communications system utilising shared circuitry. It also requires a GPS antenna and a communication antenna. The integrated communication receiver may include a component, which is shared with the GPS system. It mentions a processor that is supposed to perform the demodulation and the processing of GPS signals and communication signals. The GPS operation and the communications reception/transmission operation are typically performed at different time instants, which facilitates the use of common shared circuitry. In addition, the signal processing operations for the GPS signals is performed typically in a programmable DSP. No receiver architecture is disclosed.

In patent application EP1054265 an apparatus is disclosed for performing spread spectrum-based communication and navigation on a single device. The apparatus is provided with a receiver suitable for receiving spread spectrum-based signals as well as satellite navigation signals. The apparatus further comprises a number of tracking units that are programmable in either a navigation mode or in a communication mode and a processor.

Patent application EP 1349289 is related to a terrestrial UMTS or equivalent terminal for the reception of broadcast and/or multicast information. The terminal comprises a baseband processor that is reconfigurable for terrestrial and satellite UMTS or equivalent reception. It further comprises an internal RF front-end for terrestrial reception and a connector at intermediate frequency arranged to connect an external RF front-end for satellite UMTS reception.

### AIMS OF THE INVENTION

The present invention aims to provide a cost-effective car receiver with a low power budget that can be used in combination with a variety of broadcast and navigation signals.

### SUMMARY OF THE INVENTION

The present invention relates to a receiver system comprising a receiver module, a server subsystem to handle received data, a local storage device to retain said received data and a connectivity box for connecting external communication links.

In a preferred embodiment the local storage device is a hard disk or a DRAM memory device or a non-volatile memory device.

The connectivity box advantageously is arranged for providing a wireless link to connect a user terminal. The wireless link preferably is a WLAN or a Bluetooth interface link. In a preferred embodiment the user terminal is a mobile phone. Said mobile phone may be used as a Graphical User Interface for the applications running on the server subsystem. Alternatively the mobile phone is used to get access to missed packets via the terrestrial (cellular) network, and in this way to synchronise the data in the local storage of the car receiver with the data at the source side, i.e. at the remote server. The connectivity box may further provide a connection to a vehicle network, e.g. a MOST (Media Oriented Systems Transport) network.

Preferably the receiver module in the receiver system is a reconfigurable digital receiver module comprising
sampling means for sampling a received waveform,
a programmable logic area arranged to perform specific demodulation and decoding functions for said received waveform,
a parameterisable integrated circuit provided with interfaces with said sampling means and said programmable logic area and arranged to perform at least one function from the group of functions comprising {digital downconversion, direct digital synthesis, programmable filtering, resampling, demodulation}.

Advantageously the sampling means receive the received waveform via a RF circuit. The functions specific for the waveform are preferably parameterisable.

In a further embodiment the reconfigurable digital receiver module further comprises an embedded processor subsystem arranged for performing at least one function from the group of functions comprising {initial digital receiver configuration, runtime digital receiver control, protocol stack execution}.

In a specific embodiment a programmable logic area is integrated in the parameterisable integrated circuit. Advantageously the programmable logic area further comprises the inner modem and/or outer modem hardware functionality.

The reconfigurable digital receiver module is configured for receiving signals according to an air interface standard of the group of standards {S-DMB, DVB-S, DVB-H, DVB-H+, DVB-T, GPS, Galileo, WiMAX IEEE802.16e, IEEE802.20 MBWA).

The present invention also relates to a wireless portable device comprising a receiver system as described above.

In a further aspect the invention discloses a car comprising a receiver system as described. Preferably the receiver system is then connected to the car power supply and/or to the car's vehicle network.

In another aspect the invention relates to a method to access a service available in a receiver system as previously described through a user terminal, comprising the steps of
enabling a wireless connection between the receiver system and the user terminal,
transferring user data related to the service from the receiver system to the user terminal over the wireless connection, and
displaying the user data on a graphical user interface of the user terminal.
   Advantageously the user terminal is a handheld phone, a tablet PC, a personal digital assistant or a laptop.

In a further aspect the invention relates to a method to retrieve missing packets related to a service available in a receiver system as described, comprising the steps of
enabling a wireless connection between the receiver system and a user terminal,
establishing a connection over a cellular network between the user terminal and a content provider containing the complete user data related to the service,
transferring from the content provider to the user terminal packets missing in the user data available in the receiver system,
transferring the missing packets from the user terminal to the receiver system over the wireless connection between the receiver system and the user terminal.
   Having completed these steps the complete user data at the car receiver can be reconstructed by adding the missing packets.

The method to retrieve missing packets related to a service available in a receiver system can be used in a similar way when an external access point is present. The method then comprises the steps of
enabling a wireless connection between the receiver system and an external access point
establishing a connection between the external access point and a content provider containing the complete user data related to the service,
transferring from the content provider to the external access point packets missing in the user data available in the receiver system,
transferring the missing packets from the external access point to the receiver system over the wireless connection between the receiver system and the external access point.

### SHORT DESCRIPTION OF THE DRAWINGS

FIG. 1 represents a generic receiver architecture for automotive applications.

FIG. 2 represents a detailed view of the digital receiver architecture that can be reconfigured for processing different waveforms.

FIG. 3. represents the concept of satellite multimedia broadcast reception by a device (called ‘CarBuddy’ in the picture) mounted in a vehicle.

### DETAILED DESCRIPTION OF THE INVENTION

The car receiver as disclosed in this invention is a stand-alone receiver for a variety of broadcast schemes and navigation signals. It has a considerable local storage capability and is e.g. to be installed in the car booth or as part of the board telematics compartment. It is a small box including an antenna to be mounted on the roof of the car. This antenna can e.g. be a patch antenna providing additional gain (as compared to e.g. the antenna of a handheld wireless device), in order to boost the quality of the reception. The box is connected to the car power supply and the car multimedia bus (e.g. MOST) if present.

The receiver system can operate as an integrated system in a car multimedia environment (if existing) or independently from the car's telematics system by using the mobile phone as multimedia user interface. The connection to the mobile phone is performed through a wireless interface (such as Bluetooth or WLAN).

The strength of a receive-only system for reception of broadcast and navigation information is in its relative simplicity: it can be realised cost effectively and with a low power budget. No transmit section is included, which allows for a much simpler RF front-end, and the transmit power, which is the bulk of the power budget in a bidirectional communications terminal, is obviously not present. There is also an important simplification in the development cycle, as the regulatory aspects do not include the requirements related to transmission (except for the usual EM compliance).

In many cases, return channels can be realised also by combining the above communication standards with terrestrial systems, such as the already existing GSM/GPRS/UMTS, WLAN IEEE802.11a/b/g/ or Mobile WiMax IEEE802.16e, which is under development.

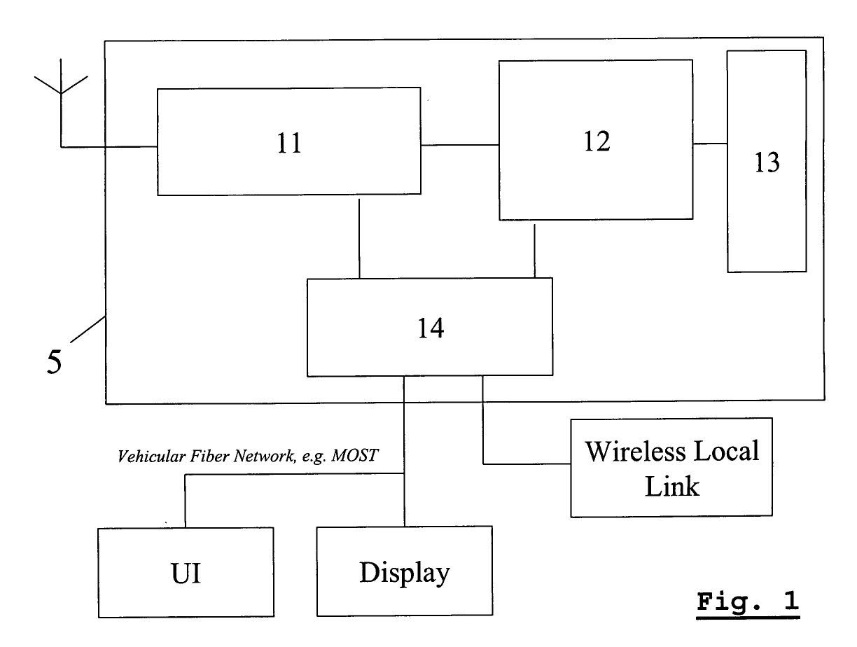

FIG. 1 depicts the high-level architecture of a generic receiver system (5) for automotive applications according to the invention. Its main elements are:
an actual receiver module (11) that downconverts, filters and demodulates the physical waveform and executes the protocol software,
a server processor (12), which controls the data flow, interacts with the buffer memory (13) and the connectivity interfaces (14) and executes the applications,
a buffer memory (13), which is a large storage device (large DRAM, hard disk or non volatile memory such as CompactFlash® or SD Card®),
a connectivity box (14), which links the receiver module (11) and its data to the car network, (e.g. Media Oriented Systems Transport (MOST) bus, i.e. an automotive interface bus standard for multimedia transport) and to the local wireless connectivity (e.g. Bluetooth, WLAN).
   These main elements are each discussed in more detail in the subsequent paragraphs.

Server processor (12) handles the control of the receiver module (11) as it receives new service data. The server also controls the streaming of received data to store locally on memory (13). It further takes care of the data interfacing with the MOST bus and the short-range link. On demand, the server sends the requested information stored on the local storage medium to the user. In case of a S-DMB receiver scheme, the server is also arranged to reconstruct missing data using the S-DMB carousel retransmit scheme. The server further also performs control and monitoring tasks and boots the receiver (11) at start-up. Using LAN (Local Area Network) and PAN (Personal Area Network) network interfaces, the server is able to connect to neighbouring mobile devices. With this local connectivity (e.g. WLAN or Bluetooth), the car receiver can connect to a mobile phone (that is equipped with a WLAN and/or a Bluetooth interface) for the following purposes:
Use the mobile phone as the GUI (Graphical User Interface) for the applications running on the server's processor of the car receiver;
Use the mobile phone to get access to missed packets via the terrestrial (cellular) network, and in this way synchronise the data in the local storage of the car receiver with the data at the source side, i.e. at the remote server.
   Using a MOST interface the server can connect to the media devices available in the car.

The buffer memory (13) is a high-capacity storage device like a large compact flash or hard disk. Preferably there is at least 4 GByte of storage available, which is technically well feasible. Taking into account a user data rate of 384 kbits/s as is the case in one of the S-DMB modes, this allows for a continuous download duration of 23 hours. Note that e.g. in a standard S-DMB mobile handset terminal no such storage capacity is provided.

The connectivity box (14) links the receiver device (11) and its data to short-range wireless connectivity. Via a wireless link such as Bluetooth or WLAN a user terminal can be connected to the car receiver. The connectivity box (14) also provides a link to the car network. This is e.g. a MOST data bus interface, as it has good capabilities for multimedia transport in the automotive environment. The user can interact with the multimedia car environment and retrieves the data via the multimedia data bus of the car. Up to 50 Mbaud is supported, which is far more than the needs of the maximum user data rate and additional signalling that need to be handled. Data communication is taking place over an optical fibre network, requiring transducers between the electric and the optical domain.

A traditional state-of-the-art receiver typically comprises an RF front-end that downconverts, amplifies and filters the antenna signal, an A/D converter that digitises the analogue signal, and a digital demodulator which performs the specific demodulation of the waveform specified in the air interface for which the receiver is intended. Protocol handling is typically done in an (embedded) processor subsystem. In high-volume applications, such a traditional receiver might be implemented as an ASIC. A full implementation of the digital part in an FPGA (Field Programmable Gate Array) is typically only done for those applications where cost and/or power consumption are less critical. The FPGA principle is based on the ability that logic functions, interconnections and memory can be configured on largely programmable modules. The versatility comes at the price of higher power consumption and higher cost, especially for complex mobile systems.

Software Defined Radio (SDR) sometimes is interpreted as a pure software implementation on an architecture based on general purpose processors or DSP processors. While this might be a power-efficient solution in a distant future, it is not a feasible option for many years, if low power consumption is a design criterion. For at least another decade a combination of hardware (logic, fixed and/or programmable) and software is required, for cost and power reasons. The present invention describes a novel approach in which a high degree of flexibility, low power consumption and low cost of implementation are reached for a broad class of emerging communication schemes. In particular, the issue of combining broadcast reception and navigation is addressed (cfr. infra).

An important aspect of the architecture is that parallelism must be achieved, certainly at the highest level of the architecture, in order to optimise (i.e. reduce) power consumption. This means that the typical approach of using hardware accelerator processors, on a common bus of another (software) processor, is avoided, because this creates a high-speed bottleneck on the bus, resulting in high clock speeds and hence high power consumption. Instead, the architecture blocks must be as much as possible organised as a concatenation of modules, i.e. with dedicated buses in between, clocked at a speed, which is a small multiple of the sampling speed, or lower.

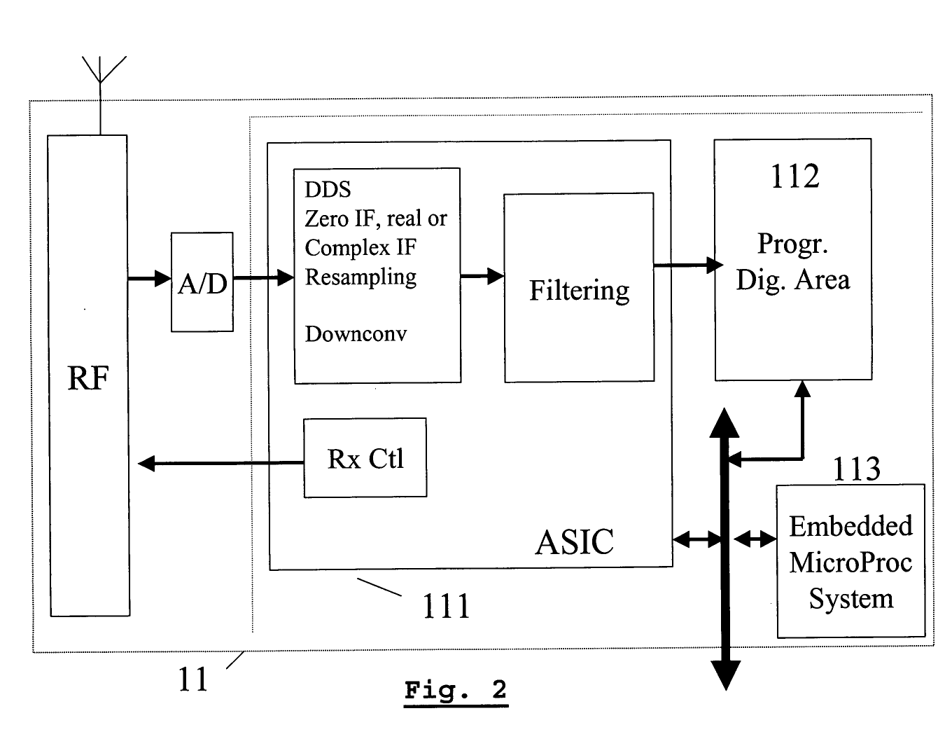

FIG. 2 shows the digital part of block (11) that receives the physical waveform and performs the protocol software processing. It contains 3 main subsystems, which altogether form the generic SDR solution: a parameterisable ASIC part (111), a programmable logic area (FPGA) (112) and a processor subsystem (113), which are further discussed more in detail.

Both FIG. 1 and FIG. 2 further show the receive antenna via which the car receiver receives a signal and demodulates the received waveform. The antenna advantageously has a shape suitable for mounting on a car's roof or in a car's window. This is e.g. possible with a patch antenna. For S-DMB the RF front-end is arranged to downconvert a receive signal of about 5 MHz wide to e.g. a 4 MHz IF carrier. A high dynamic embedded AGC is mandatory, typically offering about 80 dB dynamic range. Also a low noise figure should be achieved for the front-end, typically 8 dB or less. The A/D Converter has a sampling rate of e.g. 16 MHz in order to achieve an oversampling factor of 4. It may be a dual 10-bit converter.

The parameterisable ASIC (111) part can possibly be reconfigured through boot time or runtime parameter setting or updating. Parameter passing and control is executed by the processor subsystem. The ASIC contains flexible hi-speed hardware blocks, allowing the implementation of various receiver schemes on the car receiver SDR infrastructure, such as S-DMB, DVB-S or its derivatives, GPS, Galileo, etc. This includes blocks such as:
a. Direct Digital Synthesis (DDS) module for programmable downconversion from digital IF. This can also be a dual DDS module;
b. resampling for adapting to different oversampling rates related to symbol rates, chip rates, . . .
c. programmable filtering: not necessarily fully programmable, but allowing a wide range of lowpass and bandpass complex FIR filters,
d. (I)FFT functionality for OFDM-type of (de)modulation support,
e. clock factory,
f. watchdog and sleep mode circuitry (coupled to processor), needed because of the battery-powered operation,
g. Receiver control: AGC control, synthesiser programming, . . .
h. Interfaces: with FPGA and A/D.

Programmable logic area (FPGA) (112) contains hardware blocks, which must be fully reconfigurable, such as W-CDMA specific functionality (Rake), DVB-specific functionality (high-speed error decoding), . . . Some hardware blocks are parameterisable as well, e.g. to switch between S-DMB speed modes, or to switch between communication reception (e.g. S-DMB) and navigation reception (e.g. Galileo). The trade-off to be made here is the choice between runtime reconfigurability and runtime parameter updating. As the high-speed, complex functions already are mapped onto the ASIC, the Field Programmable Gate Array (FPGA) can be kept relatively small and cheap. Moreover, it can be clocked at relatively low speeds, which is important for the power consumption. In this way, the disadvantages of the use of large FPGAs are avoided while the advantage of full reconfigurability of a smaller FPGA is maintained.

Processor subsystem (113) performs configuration control, executes protocol software, and lower-speed demodulation/decoding functions. Patent applications WO00/69086, US2002/0196754 and EP0767544 are hereby incorporated by reference.

It is also possible to simplify the required RF circuitry by moving the lowest IF into the digital domain. This reduces the component count or BOM (Build of Materials) and hence the cost. Sampling will then be at a higher frequency than in the case of the commonly used zero IF. This might be affordable given the fact that higher speed digital part is in ASIC (where the power penalty for higher clock speeds is not that high), not in FPGA or software.

Several examples of the mapping of receiver schemes on a SDR receiver module according to the invention are now presented.

A first instance relates to an S-DMB receiver. The carrier frequency is typically in the S-band (around 2 GHz). The bandwidth and maximal data rate are 5 MHz and 384 kbits/s, respectively. In order to meet the filtering requirements a bandwidth of 5 MHz is provided. No return link capability is required for the protocol. The receiver is built around a W-CDMA like demodulator. Digital downconversion, Root Raised Cosine filtering and sample rate adaptation (if needed) are functions handled by the reconfigurable ASIC.

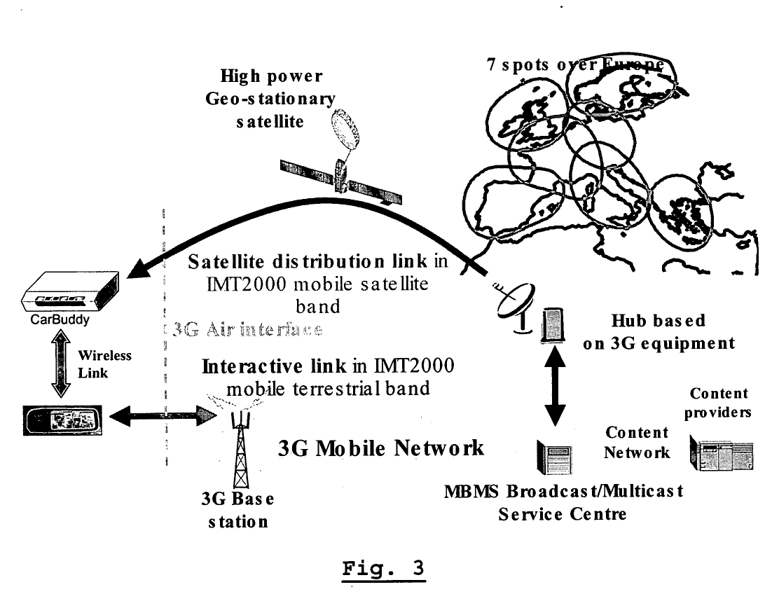

The FPGA comprises part of the Inner Modem (IM) and most of the Outer Modem (OM) hardware blocks and an embedded microcontroller subsystem. The microcontroller runs RT (real time) software in support of the IM and OM hardware blocks. In the IM the following hardware blocks are provided:
a Rake: the particular satellite/IMR (Intermediate Module Repeaters) scenario imposes the use of at least a signal that comes from the combination of 5 fingers. Spare fingers are needed in order to track the strongest paths and search new ones. At least 3 more fingers are needed for this task. A total of 8 fingers is the minimum requirement for the Rake.
for acquisition dwelling algorithms are necessary in order to catch weak pilot signals.
a demodulator able to de-scramble the received signal and to subsequently perform the despreading operation. Despreading factors range from 8 up to 128.
   In the OM there are the following hardware blocks: the first de-interleaver (10 ms de-interleaving interval), the second de-interleaver (80 ms de-interleaving interval), de-segmentation, Turbo/convolutional decoder and cyclic redundancy check.
   Extra FPGA gates are needed in order to allocate an embedded microprocessor.
   FIG. 3 shows a system context based on the S-DMB concept as it has been developed. The system comprises a car receiver as described above.
   The return channel of the car receiver system will only happen either through the handheld connected to the car receiver or through the communication systems of the car (e.g. GPRS or UMTS). To some extent, the S-DMB concept comes from the very unique and central concept of re-using 3G standards, equipment and environment in an innovative satellite system architecture. From this perspective, the most critical implementation issues arise from the requirement to interwork with other systems:
interworking of satellite and terrestrial components the S-DMB system is extending the concept of a hybrid satellite/terrestrial architecture, relying on the Wideband Code Division Multiple Access (W-CDMA) radio interface defined for UMTS terrestrial networks to achieve a coherent combination of terrestrial and satellite signals. In such a ‘single frequency same code’ radio network configuration, the satellite might be seen as a complementary signal source serving usage in rural and suburban areas, while terrestrial repeaters or IMRs (not represented in the FIG. 3) operating at the same frequency as the satellite are used to amplify the signal to enhance indoor penetration in urban areas.
Inter-working of a broadcast layer over mobile networks: the S-DMB system, inspired from the Content Delivery Network Architecture for the Internet, relies on push and store services using broadcast/multicast transmission direct to the user terminal to accommodate innovative multimedia applications in mobile networks. Pre-distribution of content will relieve terrestrial network of the most capacity-hungry traffic, and retransmission of missing blocks can be achieved using point-to-point connections to ensure high quality of service. This retransmission will happen through the user handheld or through the car communication system. After enabling a wireless connection between the car receiver system and a user terminal, a connection is established over a cellular network with a content provider (see FIG. 3) that contains all necessary data. First the missing packets are transferred from the content provider to the user terminal and subsequently further to the car receiver system. Instead of using a 3G cellular network, a connection may also be established via a WiFi network. In that case, a wireless connection is established between the car receiver system and an external access point (i.e. in a ‘hot spot’) of a WLAN network. Via that network connection, the connection with the content provider can be realised.

An alternative receiver scheme could be a DVB-S derivative, with the following features:
carrier frequency in the Ku band (10.7 to 12.75 GHz)
26 MHz to 36 MHz bandwidth
about 30 MHz filter bandwidth required
no return link capability needed for protocol
PSK modulation format
Channel decoder(s) of the Turbo type

A further possible receiver scheme is a scheme according to the DVB-T and DVB-H standard, with the following features:
carrier frequency in the UHF band (470-860 MHz)
bandwidth and max. data rate 8 MHz, 12.2 Mbits/s (QPSK), 24.4 Mbits/s (16QAM), 36.6 Mbits/s (64QAM)
filter bandwidth requirements: maximum 8 MHz channel bandwidth
no return link capability needed for protocol, although it exists (or is under development)
COFDM modulation format with resp. QPSK, 16QAM and 64QAM. The ‘inner receiver’ is FFT based.
Channel decoder(s) of the Convolutional, Turbo and interleaving type.

An important case is that of GPS.
Carrier frequency in the L-band (L1 at 1.57542 GHz and L2 at 1.22760 GHz, and the recently added L5 at 1.16 GHz)
Bandwidth: C/A code 1.023 Mchips/s, P-code 10.23 Mchips/s
Filter bandwidth requirements slightly over 1 MHz and 10 MHz, respectively
DSSS modulation format

A further example relates to a device arranged for receiving Galileo navigation signals.
Carrier frequency in the L-band (around 1.2 GHz and 1.5 GHz, as GPS)
Bandwidth: 1.023 Mchips/s or double, 5.115 Mchips/s and 10 Mchips/s
Filter bandwidth requirements: slightly over 2.5, 5 and 10 and 20 MHz, respectively
BOC (Binary Offset Carrier) and PSK modulation formats
   It should be taken into account that Galileo is partially an overlay system with GPS: the dynamic range of the A/D conversion must be sufficiently high.
   For the options above, it is assumed that they can be configured at runtime, one after the other, but not simultaneously. The combination of broadcast reception and navigation however opens a lot of commercial opportunities. Two cases can be distinguished:
1. Simultaneous reception/demodulation of communication and navigation;
2. Alternating reception/demodulation of communication and navigation signals.
   The first case is applicable if accurate position tracking is combined with a continuous data reception flow. In this case we need two separate digital processing paths. In some cases the total useful band (i.e. containing the required bandwidth of combined navigation and data) could be processed by the parameterisable area (e.g. on ASIC), using the DDS and filter capabilities in an extended fashion. The second case is applicable if the position is being tracked only on an interval basis, or when position determination is only occasionally needed (e.g. in emergency situations). This second use case is covered in the prior art (patent application EP1054265).

Wimax IEEE802.16e (and also IEEE802.MBWA that is related) are bidirectional WiFi-type of systems. They could possibly be mapped on the architecture if a return channel capability is also added to the architecture. Technically the SDR architecture presented can be extended in a straightforward way to address the transmit capabilities needed in the digital subsystem. The Wimax system has the following features:
Carrier frequency in the range from 2 to 6 GHz
Bandwidth and max. data rate 10 MHz and 30 Mbits/s, respectively.
Filtering requirements: about 15 MHz max.
return link capability is needed for protocol, as it is a bidirectional system.
OFDM, QAM, PSK modulation format
Channel decoder(s) type: Combination of convolutional, Reed-Solomon and Turbo (This is subject to change as the standardisation is still ongoing. However, as these functions are mapped on the FPGA, there is sufficient flexibility in the architecture to address such future air interface definition change).

The most important features of the various receiver schemes are summarised in Table 1, which lists the main implementation parameters for the S-DMB, Ku-Mobile (an S-DVB derivative), DVB-H, DVB-H+, DVB-T, WiMAX, GPS and Galileo use cases.

The RF frequency mentions the band, which has to be received by the external antenna and processed by the RF front-end. The A/D sampling requirements are set by the most demanding of the schemes we want to map on the SDR architecture. The maximum user data rate is listed. Some settings of the digital front-end ASIC are given, like filter bandwidth, resampling needs, use of the FFT-operation for OFDM demodulation, . . . The main specific demodulation and channel decoding functions for the FPGA target are given as well. The main software processing functions for the embedded processor are given.

TABLE 1

| | | | Max | Digital | | |
|---|---|---|---|---|---|---|
| Use | RF | A/D | Data | Front-end | FPGA Logic | SW |
| Case | frequency | Sampling | Rate | ASIC | Area | Processing |
| S-DMB | S-band: | Determined | 3384 kbits/s | Resampling | Rake | Control, |
| | 2170-2200 GHz | by Ku | | (down); | receiver; | sync; |
| | | Mobile | | 5 MHz | Hi-speed | Lower- |
| | | | | filtering | channel | speed |
| | | | | | decoding: | channel |
| | | | | | Viterbi, | decoding; |
| | | | | | Turbo, deinterleaver | Protocol |
| | | | | | | Stack |
| DVB-S | Ku- | ˜45 MHz | 1 Mbits/s | Nyquist | Despreading; | Control, |
| Deriv. | band: | max. with | | sampling; | Hi-speed | sync; |
| | 10.7-12.75 GHz | dual A/D | | 26 MHz up to | channel | Lower |
| | | converter | | 36 MHz | decoding: | speed |
| | | | | filtering; | Turbo | channel |
| | | | | | | decoding |
| DVB-T/ | UHF | Determined | 12.2 Mbits/s | COFDM demod | QPSK, | Control, |
| DVB-H | band: | by Ku | | (FFT-based); | 16QAM, | sync |
| | 470-860 MHz | Mobile | | Resampling | 64QAM | |
| | | | | (down); | demod. Hi- | |
| | | | | 8 MHz | speed | |
| | | | | filtering | channel | |
| | | | | | decoding: | |
| | | | | | Viterbi, | |
| | | | | | Turbo, deinterleaver | |
| WiMAX | 2-6 GHz | ˜15 MHz | Up to | OFDM demod | PSK, QAM | Control, |
| IEEE | | | 30 Mbits/s | (FFT based); | Combination | sync |
| 802.16e | | | | | of Viterbi, | |
| | | | | | Reed- | |
| | | | | | Solomon and | |
| | | | | | Turbo | |
| | | | | | decoding | |
| GPS | 1.2 and | Determined | NA | On 2^{nd} | // Tracking | Tracking |
| | 1.5 GHz | by Galileo | | channel; | Units | control; |
| | | | | Resampling | | Position |
| | | | | (down); 2 . . . 3 × Nyquist | | fix |
| | | | | filtering | | |
| Galileo | 1.2 and | Max. 20 . . . 30 MHz | NA | On 2^{nd} | // Tracking | Tracking |
| | 1.5 GHz | for 10 Mchips/s | | channel; 2 . . . 3 × Nyquist | Units | control; |
| | | option | | filtering | | Position |
| | | | | | | fix |

In the paragraphs below, an example of a possible implementation of the car receiver is given.

A hardware case is designed in order to provide housing for the hardware components, mounting means for the car receiver and access to the I/O and power supply connectors. The hardware box will carry the following elements:
a PCB containing all car receiver components: S-DMB modem, S-DMB server, Local Storage, WLAN and/or Bluetooth interface,
Car interface: MOST bus connector,
Antenna connector,
Antenna connector for short-range wireless link (WLAN and/or Bluetooth),
Power supply interface (plus voltage peak shield). Preferably the car receiver operates at a 12 V car battery.
Internal diagnostics connector (USB, RJ45, serial . . . )
Cooling slits

Advantages of the invention are manifold. It offers a solution for the architecture of a device for addressing multiple broadcast formats in an efficient way. More in particular, it contains
a format independent core, software configurable to the application needs,
programmable logic able to support format specific circuits,
an embedded processor, responsible for the parameterisation of the different reconfigurable blocks, supporting also the protocol stack activities,
memories containing the hard reconfigurable image of formats and the necessary software (program and data),
interfaces (including wireless interfaces) to the personal mobile device or the car specific busses such as MOST.

The embedded processor handles the received data, interfaces with the wireless connectivity provisions and with the car's multimedia bus, and supports the application processing. The wireless connectivity can be used to link the car receiver with an external mobile phone. This allows to use that external handset to act as a GUI for the applications running on the server subsystem, or to retrieve missing packets, through the cellular link that can be set up via the handset.

There are multiple advantages
no need for a new car system implementation (displays etc) in existing cars, which allow the user to avoid new equipment mounting costs,
accessibility to the information outside of the car by storing the services in the passenger handheld device,
private passenger sessions as they can select the type of information they want to receive,
most of the current phones are already multimedia enabled, hence no extra cost for the user,
cheap way to connect the car multimedia system together with the passenger mobile through short range available wireless links (WLAN or Bluetooth)

Also for the end user the solution according to the invention offers many advantages:
It allows the user to receive multimedia services such as news, events, meteorological and traffic data, . . . on his/her terminal.
The newly received content shall be automatically downloaded to the car receiver's storage memory. This content stored locally is accessible by the user on demand. The access to the content does not require the user to connect to the network as the content is already available locally. The user experiences a virtual interactivity.
In order to limit the quantity of information the phone needs to store, a user preferences profile shall filter the received content (e.g. sport preference, games type) prior to storage. Only the relevant content defined by the user will be stored locally.
The cost is kept low because of the implementation as receive-only device (return link capability is offered by an interface to the terrestrial network), a high degree of integration and a moderately simple antenna.
The service allows the end user to access a rich environment of tailored multimedia content. These services can be broadcast continuously to update the memory content of the user terminal. The main objective of the concept behind the service is to add a broadcast/multicast layer on top of a 3G cellular network (UMTS) using a combined satellite and terrestrial (i.e. the repeaters network) component architecture. In case of a S-DMB scenario, operators can broadcast multimedia information in a cost-effective way to the user terminals, because the additional load of download services on a terrestrial network would take a large part of the available capacity, which is very expensive.
The car receiver allows immediate full coverage service (it does not suffer from shadowing and in-building deterioration), and a high Quality of Service for streaming the application. This is possible for outdoor situations and some indoor situations (e.g. covered parking lots).
The service is transparent from a user point of view, meaning that he is not aware whether the signal originates from a satellite or from a terrestrial network.
Thanks to the short-range wireless link the car receiver provides an extension in the automotive environment.

Applications of a miniaturised broadcast receiver are manifold and include:
Car-mounted receivers for receiving and handling multimedia content resulting from S-DMB, DVB-T, DVB-H, DVB-H+, possibly combined with navigation reception;
Wireless tourist guides, such as with extension cards on PDA's; regular download of e-books to electronic book readers and newspapers and magazines (and e.g. short inline video sequences) towards tablet PCs.

What is claimed is:

1. Receiver system comprising a receiver module, a server subsystem to handle received data, a local storage device to retain said received data and a connectivity box for connecting external links.

2. Receiver system as in claim 1, wherein said local storage device is a hard disk or a DRAM memory device or a non-volatile memory device.

3. Receiver system as in claim 1, wherein said connectivity box is arranged for providing a wireless link to connect a user terminal.

4. Receiver system as in claim 3, wherein said wireless link is a WLAN or a Bluetooth link.

5. Receiver system as in claim 1, wherein said connectivity box provides a connection to a vehicle network.

6. Receiver system as in claim 5, wherein said vehicle network is a MOST network.

7. Receiver system as in claim 1, wherein said receiver module is a reconfigurable digital receiver module comprising:
sampling means for sampling a received waveform,
a programmable logic area arranged to perform specific demodulation and decoding functions for said received waveform, and
a parameterisable integrated circuit provided with interfaces with said sampler and said programmable logic area and arranged to perform at least one function selected from the group of functions consisting of: digital downconversion, direct digital synthesis, programmable filtering, resampling, and demodulation}.

8. Receiver system as in claim 7, wherein said sampler receive said received waveform via a RF circuit.

9. Receiver system as in claim 7, wherein said functions specific for said waveform are parameterisable.

10. Receiver system as in claim 7, wherein said reconfigurable digital receiver module further comprises an embedded processor subsystem arranged for performing at least one function selected from the group of functions consisting of: initial digital receiver configuration, runtime digital receiver control, and protocol stack execution.

11. Receiver system as in claim 7, wherein said programmable logic area is integrated in said parameterisable integrated circuit.

12. Receiver system as in claim 7, wherein said reconfigurable digital receiver module is configured for receiving signals from at least one standard selected from the group consisting of: S-DMB, DVB-S, DVB-H, DVB-H+, DVB-T, GPS, Galileo, WiMAX IEEE802.16e, and IEEE802.20 MBWA.

13. Receiver system as in claim 7, wherein said reconfigurable digital receiver module further comprises a transmitter to provide a return channel.

14. Receiver system as in claim 7, further comprising an antenna for receiving data.

15. Wireless portable device comprising a receiver system comprising a receiver module, a server subsystem to handle received data, a local storage device to retain said received data and a connectivity box for connecting external links.

16. Car comprising a receiver system comprising a receiver module, a server subsystem to handle received data, a local storage device to retain said received data and a connectivity box for connecting external links.

17. Car as in claim 16, wherein said receiver system is connected to the car power supply.

18. Method to access a service available in a receiver system comprising a receiver module, a server subsystem to handle received data, a local storage device to retain said received data and a connectivity box for connecting external links through a user terminal, comprising the steps of:
enabling a wireless connection between said receiver system and said user terminal,
transferring user data related to said service from said receiver system to said user terminal over said wireless connection, and
displaying said user data on a graphical user interface of said user terminal.

19. Method to access a service available in a receiver system as in claim 18, wherein said user terminal is a handheld phone, a tablet PC, a personal digital assistant or a laptop.

20. Method to retrieve missing packets related to a service available in a receiver system comprising a receiver module, a server subsystem to handle received data, a local storage device to retain said received data and a connectivity box for connecting external link, comprising the steps of:
enabling a wireless connection between said receiver system and a user terminal,
establishing a connection over a cellular network between said user terminal and a content provider containing the complete user data related to said service,
transferring from said content provider to said user terminal packets missing in the user data available in said receiver system, and
transferring said missing packets from said user terminal to said receiver system over said wireless connection between said receiver system and said user terminal.

21. Method to retrieve missing packets related to a service available in a receiver system comprising a receiver module, a server subsystem to handle received data, a local storage device to retain said received data and a connectivity box for connecting external links, comprising the steps of:
enabling a wireless connection between said receiver system and an external access point,
establishing a connection between said external access point and a content provider containing the complete user data related to said service,
transferring from said content provider to said external access point packets missing in the user data available in said receiver system, and
transferring said missing packets from said external access point to said receiver system over said wireless connection between said receiver system and said external access point.
